(19) United States
(12) Patent Application Publication
(10) Pub. No.: US 2019/0007881 A1
(43) Pub. Date: Jan. 3, 2019

(54) METHODS, NETWORK NODE AND WIRELESS DEVICE FOR ENABLING ACCESS TO A WIRELESS NETWORK

(71) Applicant: Telefonaktiebolaget LM Ericsson (publ), Stockholm (SE)

(72) Inventors: Pradeepa Ramachandra, Linköping (SE); Icaro Leonardo J. Da Silva, Solna (SE); Andres Reial, Malmö (SE)

(21) Appl. No.: 15/736,217

(22) PCT Filed: Oct. 27, 2017
(86) PCT No.: PCT/SE2017/051056

§ 371 Date: Dec. 13, 2017

Related U.S. Application Data
(60) Provisional application No. 62/422,131, filed on Nov. 15, 2016.

(51) Int. Cl. H04W 36/16; H04L 5/00; H04W 74/08; H04W 24/10; H04W 36/30

(52) U.S. Cl. CPC H04W 36/165; H04L 5/0048; H04W 36/30; H04W 24/10; H04W 74/0833

(57) ABSTRACT

A network node, a wireless device and methods therein, for enabling the wireless device to access a wireless network. The network node configures the wireless device with a set of serving reference signals to be measured by the wireless device in inactive/idle mode, wherein the serving reference signals are also used by wireless devices in active mode. When the network node transmits the set of serving reference signals according to a predefined scheme, a Physical Random Access Channel, PRACH, preamble associated with one of the serving reference signals, is received from the wireless device and a connection with the wireless device is established based on the received PRACH preamble. Thereby, the risk for an immediate handover or cell re-selection of the wireless device after a state transition between active mode and idle/inactive mode can be reduced since the serving reference signals are used by wireless device in both modes.

### TECHNICAL FIELD

The present disclosure relates generally to a network node, a wireless device and methods therein, for enabling the wireless device to access a wireless network.

### BACKGROUND

In this disclosure, the term “wireless device” is used to represent any communication entity capable of radio communication with a wireless network by sending and receiving radio signals, such as e.g. mobile telephones, tablets, laptop computers and Machine-to-Machine, M2M, devices, also known as Machine Type Communication, MTC, devices. Another common generic term in this field is “User Equipment, UE” which is sometimes used herein as a synonym for wireless device.

Further, the term “network node”, is used herein to represent any node of a radio network that is operative to provide radio access for a wireless device by radio communication in a certain coverage area such as a cell or a beam. The network node in this disclosure may refer to any of a base station, radio node, Node B (NB), base transceiver station, access point, Transmission/Reception Point (TRP), Radio Base Station (RBS), eNB, gNB, etc., which communicates radio signals with the wireless device. The network node in this disclosure may also refer to a node in the network, such as a Radio Network Controller, RNC, that controls one or more base stations or radio nodes that communicate radio signals with wireless devices. Further, according to customary terminology, a radio technology used for fifth Generation 5G communication is referred to as “New or Next Radio”, or NR for short.

When a wireless device operates in a wireless network, it may be necessary to change a connection for the wireless device from a current serving network node to a new target network node, to maintain effective and reliable communication with the network. This process is generally referred to as handover when the wireless device is in active mode or cell re-selection when the wireless device is in idle or inactive mode. According to further common terminology, the active mode is also referred to as RRC CONNECTED and the idle or inactive mode is also referred to as RRC INACTIVE/IDLE where RRC=Radio Resource Control.

The amount of available radio resources in a wireless network is limited and typically precious, and it is desirable to use these radio resources as efficiently as possible in order to achieve high capacity of the network. Consequently, it is a problem that the above-mentioned handover and cell re-selection processes typically require substantial signaling between the network and the wireless device which consumes radio resources in the network, and that sometimes handover or cell re-selection are performed excessively often. It is further generally desirable to reduce the amount of signaling in a wireless network, e.g. by reducing the number of handovers and cell re-selections.

### SUMMARY

It is an object of embodiments described herein to address at least some of the problems and issues outlined above. It is possible to achieve this object and others by using a network node, a wireless device and methods therein as defined in the attached independent claims.

According to one aspect, a method is performed by a network node of a wireless network, for enabling a wireless device to access the wireless network. In this method, the network node configures the wireless device with a set of serving reference signals to be measured by the wireless device in inactive/idle mode, wherein the serving reference signals are also used by wireless devices in active mode. The network node also transmits the set of serving reference signals according to a predefined scheme.

At some point, the network node further receives from the wireless device a Physical Random Access Channel, PRACH, preamble associated with one of the serving reference signals, and the network node then establishes a connection with the wireless device based on the received PRACH preamble.

Among other things, it is an advantage that the risk for an immediate handover or cell re-selection of the wireless device after a state transition between the active and idle/inactive modes can thereby be reduced since the coverage provided by the serving reference signals is basically the same in both modes. Avoided handover or cell re-selection thus leads to reduced signaling and saved resources.

According to another aspect, a network node is arranged to enable a wireless device to access a wireless network. The network node is configured or operable to configure the wireless device with a set of serving reference signals, to be measured by the wireless device in inactive/idle mode, wherein the serving reference signals are also used by wireless devices in active mode. The network node is also configured to transmit the set of serving reference signals according to a predefined scheme.

The network node is further configured to receive from the wireless device a PRACH preamble associated with one of the serving reference signals, and to establish a connection with the wireless device based on the received PRACH preamble.

According to another aspect, a method is performed by a wireless device for accessing a wireless network. In this method, the wireless device receives from a serving network node a configuration comprising a set of serving reference signals, wherein the serving reference signals are also used by wireless devices in active mode, and performs measurements on the configured set of serving reference signals or MRSs when the wireless device is in inactive/idle mode.

When detecting that a transition from inactive/idle mode to active mode is required or desirable, the wireless device accesses the wireless network by sending to the serving network node a PRACH preamble associated with one of the measured serving reference signals that is the best, or at least acceptable, serving reference signal.

According to another aspect, a wireless device is arranged to access a wireless network as follows. The wireless device is configured to receive from a serving network node a configuration comprising a set of serving reference signals, wherein the serving reference signals are also used by wireless devices in active mode.

The wireless device is also configured to perform measurements on the configured set of serving reference signals or MRSs when the wireless device is in inactive/idle mode. The wireless device is further configured to detect that a transition from inactive/idle mode to active mode is required or desirable, and then to access the wireless network by sending to the serving network node a PRACH preamble associated with one of the measured serving reference signals that is the best, or at least acceptable, serving reference signal.

The above network node, wireless device and methods may be configured and implemented according to different optional embodiments to accomplish further features and benefits, to be described below.

A computer program is also provided comprising instructions which, when executed on at least one processor in either of the network node and the wireless device, cause the at least one processor to carry out the respective methods described above. A carrier is also provided which contains the above computer program, wherein the carrier is one of an electronic signal, optical signal, radio signal, or a computer readable storage medium.

### BRIEF DESCRIPTION OF DRAWINGS

The solution will now be described in more detail by means of exemplary embodiments and with reference to the accompanying drawings, in which:

FIG. 1 is an overview of a proposed solution for system information acquisition in Next or New Radio, NR.

FIG. 2 is an overview of the downlink based active mode mobility solution proposed for 3GPP 5G Next or New Radio, NR.

FIG. 3 is an overview of a scenario with a possible ping-pong region at state transition while having different active and idle/inactive mode coverage.

FIG. 4 is a flow chart illustrating a procedure in a network node, according to some possible embodiments.

FIG. 5 is a flow chart illustrating a procedure in a wireless device, according to further possible embodiments.

FIG. 6 is a signaling diagram illustrating an example of a procedure when the solution is used, according to further possible embodiments.

FIG. 7 is a block diagram illustrating a network node and a wireless device in more detail, according to further possible embodiments.

### DETAILED DESCRIPTION

In the following, a transition between the active and idle/inactive modes is referred to as a “state transition”, which could also be denoted a mode transition.

An example of a proposed procedure for system information acquisition for 5G Next Radio, NR, is depicted in FIG. 1. In this example, each network node 100, 102, which could be a TRP or RBS or eNB or gNB, transmits a synchronization signal or a system signature signal (SS). A wireless device 104, in this example called UE, is connected to the network node 100. Together with the SS, each network node also transmits a physical broadcast channel (PBCH) containing some of the minimum system information that the UE needs to access the network. This part of the minimum system information is denoted as master information block (MIB) in the figure. The transmission of SS and the PBCH containing the MIB is indicated by dashed/dotted ovals in the figure. Thus, one network node 100 transmits an SS denoted SS₁ and a MIB denoted MIB₁ while another network node 102 transmits another SS denoted SS₂ and another MIB denoted MIB₂ within the respective coverage areas as illustrated.

By reading the MIB, the UE 104 receives and obtains information on how to receive the system information block (SIB) table. The SIB table may be transmitted using a broadcast format such as single frequency network (SFN) transmission and it is depicted with a dashed oval in the figure. The coverage area for the SIB table is thus relatively large and may basically cover and extend beyond both coverage areas for the SSs+MIBs, as shown.

In addition to the minimum system information that is periodically broadcasted in the SS+MIB and in the SIB-table, the UE 104 may receive other “additional” system information, e.g. by a dedicated transmission from network node 100 after initial access has been established for the UE 104, which is depicted with a full line lobe in the figure. The UE 104 is thus in the active mode.

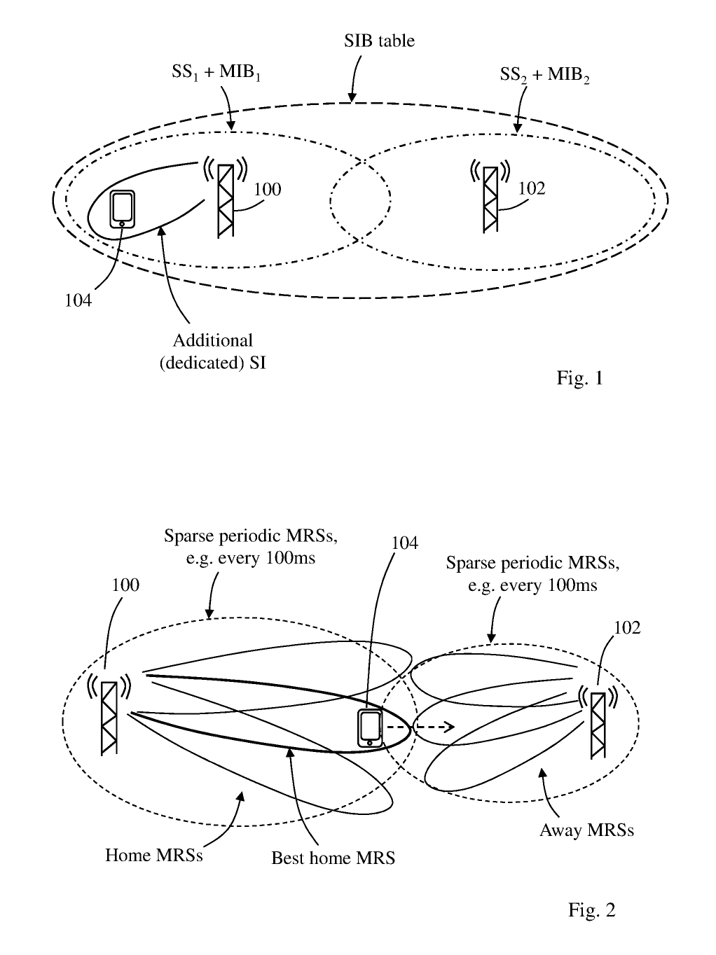

A procedure which has been proposed for downlink based active mode mobility in NR, is depicted in FIG. 2, again involving two network nodes 100, 102 and a UE 104. The UE 104 is served by the leftmost node 100 but is traveling in the direction towards the rightmost node 102, as depicted by a dashed arrow in the figure. Each network node 100, 102 transmits MRSs in different beams or lobes and the MRSs from the serving network node 100 are denoted “home MRSs” while the MRSs from the non-serving network node 102 are denoted “away MRSs”. The UE 104 uses the best “home MRS” for coarse timing estimation and radio link quality monitoring and failure detection, and the transmission of this MRS is indicated by a thick lined lobe from network node 100 in the figure. Transmission of other home MRSs is indicated by thinner lined lobes from network node 100.

In addition, the UE monitors a sparse periodic MRS from the serving network node 100 and compares it with similar periodic and sparse MRSs from potential target nodes such as the other network node 102. The transmission of sparse periodic MRSs from network nodes 100 and 102 is indicated by respective dashed ovals and may occur every 100 ms as an example. When a target node becomes relevant for a more detailed handover procedure, additional dynamically configured home MRSs and dynamically configured away MRSs may be activated.

The final handover decision is taken by the network and it is based on UE reports containing measurements of home MRSs transmitted from the serving network node 100 and measurements of away MRSs transmitted from other network nodes such as network node 102.

When the above-described proposed procedure is used, a UE undergoing a state transition in NR from RRC INACTIVE/IDLE mode to RRC CONNECTED mode will perform an initial access procedure wherein the UE accesses the system information using the above-described SS transmission from network nodes, which could be wide beamformed in some scenarios to gain SFN benefits. After accessing the system information via wide beamformed SS transmissions, the UE will receive active mode related configurations which may include beamformed signals such as MRSs.

The same arguments could be valid for high frequency deployments as well. The network could thus enable the transmission of beamformed SS in high frequencies. In such a scenario, the transmission of system information in each of the beams might be considered too expensive in terms of processing and consumed radio resources. Therefore, a possible compromised solution would be to use wider beams for SS and system information transmission.

A limitation of such a transmission on wider beams may be that there is a slightly longer delay in recognizing a narrower downlink beam transmitted towards the UE once the UE accesses the network via a wider beam, and then the UE must provide feedback with signal measurements, such as a Channel State Information, CSI, report or MRS report, to the network in order to obtain narrow beams for data reception.

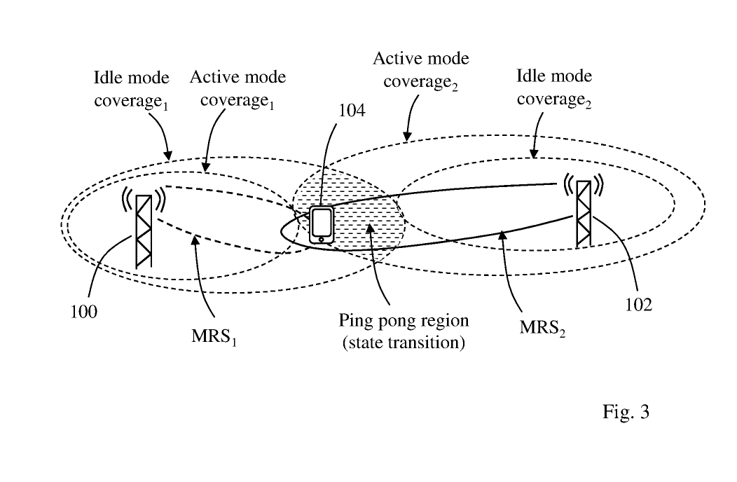

In the embodiments described herein, it has been recognized that when different beamformers are used for idle/inactive mode SS transmission and active mode Reference Signal (RS) transmission in a wireless network, there can be different coverages for idle/inactive mode SS transmission from a network node, compared to the active mode RS transmission from the same network node. An example of such a scenario is shown in FIG. 3, likewise involving two network nodes 100, 102 and a UE 104. In this example, it can be seen that each of the network nodes 100, 102 has different coverage areas for wireless devices in idle/inactive mode and for wireless devices in active mode, e.g. for the reasons explained above.

In this figure, the UE 104 is located in the dashed region termed as ‘ping-pong region’ where a state transition between idle/inactive mode and active mode may result in handover or cell re-selection as follows. The ping-pong region is within the coverage area of network node 100 for idle/inactive mode, denoted “Idle mode coverage₁”, and also within the coverage area of network node 102 for active mode, denoted “Active mode coverage₂”. As a result, the UE 104 camps on the left network node 100 when in the idle/inactive mode, and when the UE 104 accesses the network, the UE will initially connect to the left network node 100. Once the UE 104 connects to that node 100, the UE will be configured with active mode MRSs to be measured. The UE 104 then reports that the MRSs from the right network node 102 are better received and hence the UE 104 will immediately get handed over to the right network node 102, even if the UE basically stays in the same position, by being within the Active mode coverage₂ but outside the Active mode coverage₁. This ping-pong behavior will increase the network signaling and could hamper the UE throughput of communicated data.

The above problem is thus recognized in this solution and could be particularly significant for those UEs that are static or slowly moving in nature. Such a UE will typically end up getting the ping-pong behavior at every state transition in a ping-pong region due to the changed coverage. In FIG. 3 for example, the dashed ping pong region has idle mode coverage from network node 100 but not active mode coverage, while it has active mode coverage from the other network node 102 but not idle mode coverage. As a result, the UE may have to switch connection, either by handover or by re-selection, at every state transition when located in the ping pong region.

Based on the existing LTE networks, it can be expected that the UE tends to do many state transitions in the same cell by going from idle to connected to idle to connected, and so forth, before either performing handover or doing a cell re-selection. As LTE do not have different coverages for UEs in idle mode and for UEs in active mode, the above mentioned problem is applicable to technologies that can have different coverages for idle/inactive mode and active mode, which is the case for NR technologies.

The above drawbacks and problems may be overcome or at least reduced by employing a solution as described below. The ping pong behavior such as described above for FIG. 3 can be avoided by configuring the wireless device with a set of serving reference signals to be measured in idle/inactive mode, wherein the serving reference signals are also used by wireless devices in active mode, according to embodiments herein.

Considering that most of the state transitions of a UE occur within the same cell, i.e. the UE goes to idle/inactive and comes back to active in the same cell, in the embodiments herein the serving network node configures the UE with a set of serving reference signals such as MRSs, to be used in Idle/Inactive mode together with their associated PRACH configurations, so that the UE can camp on the serving MRSs. If there is incoming uplink data or if a page is received, or if the UE detects that a tracking area update is required due to cell re-selection, the UE can send a PRACH preamble associated with the configuration provided by the network, i.e. one of the serving MRSs configured by the network node.

According to some embodiments herein, the UE may thus camp on the serving set of MRSs when these are present, and the UE may camp on the SS when the MRSs are not configured. For example, The MRSs described herein may be CSI-RSs.

Some advantages that can be achieved by employing the embodiments herein may include any of:
1) Reduced handovers soon after the state transitions, resulting in reduced network signaling in a network with different active and idle/inactive mode coverages.
2) Quicker availability of narrow beamforming of data towards the UEs in the downlink.
3) Allows the UE to camp on beamformed signals, but since these signals do not provide initial access the system information/PRACH configuration does not need to be beamformed accordingly.

In some embodiments, the validity of the MRS set configuration may be per cell, which is useful in most situations. In some other embodiments, the MRS configuration may also comprise a set of cells, which is useful e.g. in the case of a centralized RNC where a common configuration for multiple TRPs or network nodes is quite easy to accomplish. In other multi-cell cases, some inter-node coordination of the MRS configurations may be required to enable a common MRS configuration. Such coordination may use common central allocation or negotiation approaches.

To cover the case of multi-cell communication, the UE goes to the idle/inactive mode and receives the configuration of MRS sets per cell for a group of cells e.g. within a given area. The UE should update the network with cell re-selection information once it has detected that it has moved outside that group of cells, e.g. by detecting that other MRSs are received with better quality. In one embodiment, the UE is configured with other (non-serving) MRS sets to be compared with the serving MRS set. In other embodiments, the UE may compare the serving MRS set to any other audible MRS set. The relevant and comparable MRS sets may then be identified by certain bit patterns in the MRS index they encode. During a Resume operation before this update, the UE can be re-configured with a new set of MRSs for camping and their associated PRACH resources, also per cell and/or per tracking area.

The embodiments herein may further be applied on UEs that match a specific behavior pattern: UE goes to idle/inactive mode, moves and stays longer in the area i.e. it is likely to transit to the active mode again when still in that area. For cases where the UE is moving a great deal, the network might not employ MRS camping for the UE and the traditional SS-based camping can be used instead.

In some embodiments, the configuration of the MRS set(s) may also involve a timer which can be triggered by the UE upon entering the idle/inactive mode, and the duration of the timer is the validity period of said configuration related to MRS sets and corresponding PRACH resources. When the timer expires, the only method of accessing the network again is via idle mode SS which is used in the normal initial access. Such an embodiment allows the network to change the MRS beamforming properties and knowing whether such a change will affect the UEs in idle/inactive mode or not.

The embodiments herein provide a procedure to configure the UE with a set of serving MRSs and their corresponding PRACH resources that the UE can use in order to access the network while transitioning from idle/inactive mode to the active mode to enable faster access and faster reception of data in narrow beams.

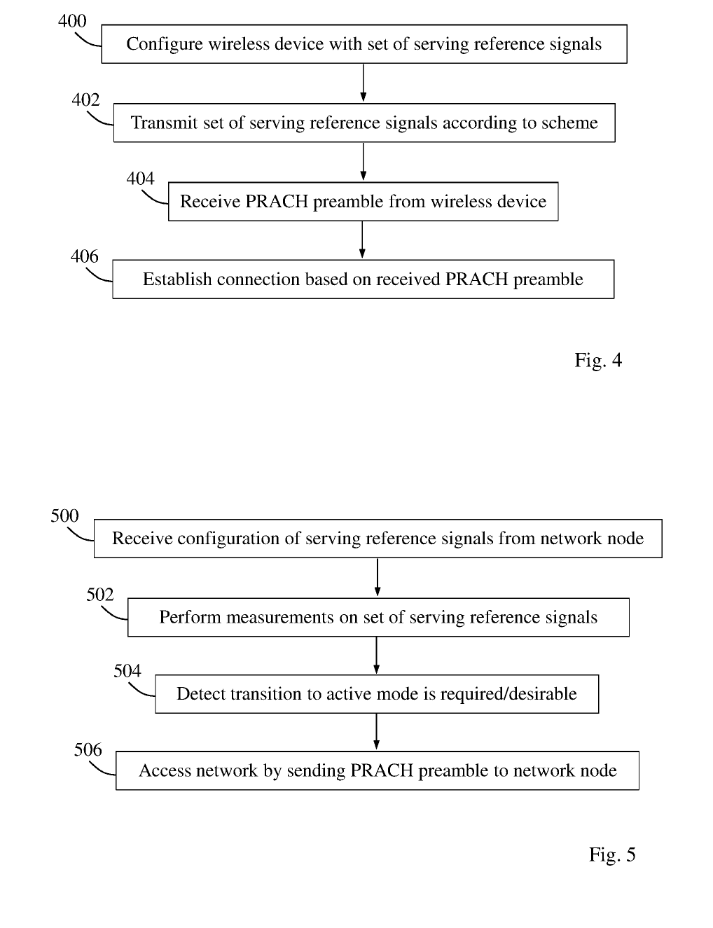

An example of how the solution may be employed in terms of actions performed by a network node, is illustrated by the flow chart in FIG. 4 which will now be described. FIG. 4 thus illustrates a procedure in the network node for enabling a wireless device to access the wireless network.

A first action 400 illustrates that the network node configures the wireless device with a set of serving reference signals, such as a set of serving MRSs, to be measured by the wireless device in inactive/idle mode, wherein the serving reference signals are also used by wireless devices in active mode. In another action 402, the network node further transmits the set of serving reference signals according to a predefined scheme. The network node further receives from the wireless device a Physical Random Access Channel, PRACH, preamble associated with one of the serving reference signals, as shown in action 404. In a final action 406, the network node establishes a connection with the wireless device based on the received PRACH preamble.

Some example embodiments that may be employed in the above procedure of FIG. 4, will now be described.

In one example embodiment, said set of serving reference signals may be a set of serving Mobility Reference Signals MRSs which are transmitted as beamformed signals. As mentioned above, CSI-RSs may be used as the MRSs mentioned herein.

In another example embodiment, validity of the set of serving MRSs may be per cell, meaning that one set of serving MRSs could be valid for one cell, while another set of serving MRSs could be valid for another cell, and so forth. In another example embodiment, validity of the set of serving MRSs may also be for a set of multiple cells, meaning that one set of serving MRSs could be valid for one set of cells, while another set of serving MRSs could be valid for another set of cells, and so forth. The above embodiments do not exclude that a particular set of serving MRSs could be valid for more than one cell or for more than one set of cells, respectively.

In another example embodiment, the wireless device may be further configured with other non-serving MRS sets for comparison with the set of serving MRSs. If so, another example embodiment could be that the wireless device is further configured with a timer which can be triggered by the wireless device upon entering the idle/inactive mode, and the duration of the timer could then be the validity period of the configuration related to the MRS sets and corresponding PRACH resources.

In another example embodiment, the wireless device may be further configured with PRACH resources associated with the MRSs including said PRACH preamble, so that the wireless device can camp on the MRSs. In another example embodiment, the set of serving reference signals as of the procedure in FIG. 4 could be applied on wireless devices that match a specific behaviour pattern of entering the inactive/idle mode and staying in an area covered by the set of serving reference signals.

Another example of how the solution may be employed in terms of actions performed by a wireless device, such as the wireless device involved in the procedure of FIG. 4, is further illustrated by the flow chart in FIG. 5 which will now be described likewise with further reference to FIG. 4. FIG. 5 thus illustrates a procedure in the wireless device for accessing a wireless network.

A first action 500 illustrates that the wireless device receives from a serving network node, such as the network node involved in the procedure of FIG. 4, a configuration comprising a set of serving reference signals, such as a set of serving MRSs, wherein the serving reference signals are also used by wireless devices in active mode, which corresponds to action 400. A further action 502 illustrates that the wireless device performs measurements on the configured set of serving reference signals when the wireless device is in inactive/idle mode. In another action 504, the wireless device detects that a transition from inactive/idle mode to active mode is required or desirable.

In another action 506, the wireless device accesses the wireless network by sending to the serving network node a Physical Random Access Channel, PRACH, preamble associated with one of the measured serving reference signals that is the best, or at least acceptable, serving reference signal. Action 506 corresponds to action 404.

Some example embodiments that may be employed in the above procedure of FIG. 5, will now be described.

In one example embodiment, said set of serving reference signals may be a set of serving Mobility Reference Signals MRSs which are transmitted as beamformed signals. As mentioned above, CSI-RSs may be used as the MRSs mentioned herein.

In another example embodiment, validity of the set of serving MRSs may be per cell, as explained above. In another example embodiment, validity of the set of serving MRSs may also be for a set of multiple cells, as likewise explained above. The above embodiments do not exclude that a particular set of serving MRSs could be valid for more than one cell or for more than one set of cells, respectively.

In another example embodiment, the wireless device may be further configured with other non-serving MRS sets for comparison with the set of serving MRSs. If so, another example embodiment could be that the wireless device is further configured with a timer which can be triggered by the wireless device upon entering the idle/inactive mode, and the duration of the timer could then be the validity period of the configuration related to the MRS sets and corresponding PRACH resources.

In another example embodiment, the wireless device may be further configured with PRACH resources associated with the MRSs including said PRACH preamble, so that the wireless device can camp on the MRSs. In another example embodiment, the procedure in FIG. 5 could be applied when the wireless device matches a specific behaviour pattern of entering the inactive/idle mode and staying in an area covered by the set of serving reference signals.

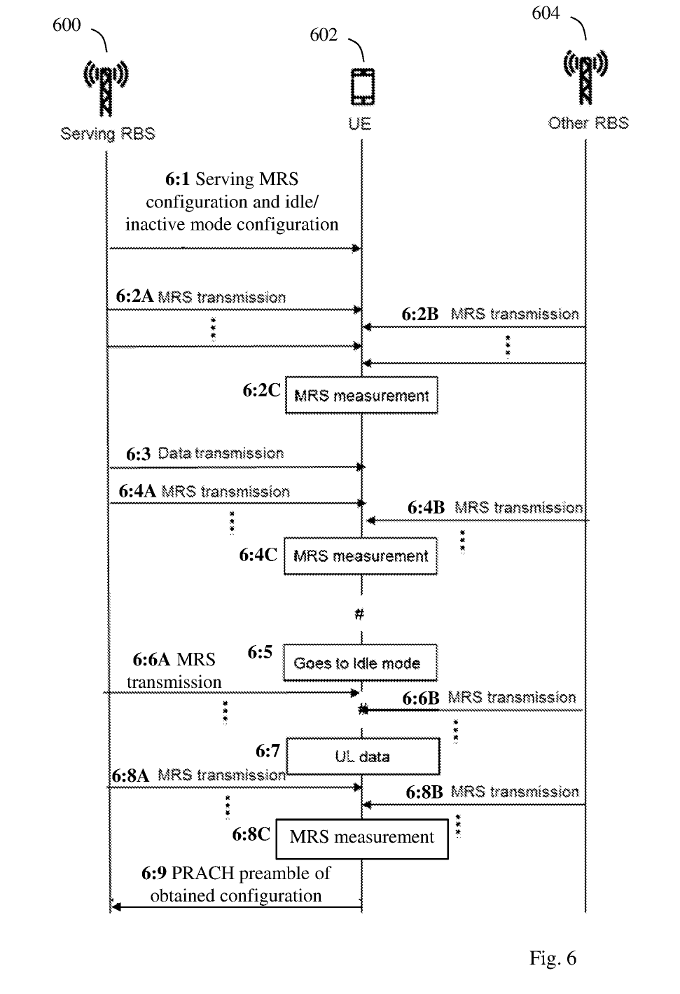

A simple schematic signaling procedure that may be used when employing the solution is shown in FIG. 6 where the term “UE” represents a wireless device and the term “RBS” represents a network node.

Here, the serving network node 600, denoted “serving RBS”, configures the wireless device 602 with certain serving MRS sets that can be used, if present, to access the serving network node 600 again via specific PRACH indicator corresponding to the “best” received MRS, as measured by the wireless device 602, when the device desires or is required to transit from the idle/inactive mode to the active mode. FIG. 6 also illustrates that one or more other network nodes 604, denoted “other RBS”, may likewise transmit their sets of serving MRSs in the manner described for the network node 600, so that the wireless device 602 is able to measure those MRSs as well for comparison.

In a first action 6:1, the serving RBS 600 configures the wireless device 602 with a set of serving MRSs to be measured in the idle/inactive mode, which MRSs are also used by wireless devices in the active mode, which corresponds to the above actions 400 and 500. Actions 6:2A and 6:2B illustrate that the serving RBS 600 and the other RBS 604 transmit their sets of MRSs, and action 6:2C illustrates that the wireless device 602 performs measurements on the transmitted MRSs in the idle/inactive mode.

A next action 6:3 illustrates that the serving RBS 600 transmits data to the wireless device 602 which therefore goes to the active mode. In further actions 6:4A, 6:4B the serving RBS 600 and the other RBS 604 transmit their sets of MRSs, and the wireless device 602 performs measurements on the transmitted MRSs in the active mode in action 6:4C.

After a period of inactivity, the wireless device 602 goes back to the idle/inactive mode in action 6:5, and continues to receive MRS transmissions from the serving RBS 600 and the other RBS 604, in respective actions 6:6A, 6:6B. In action 6:7, the wireless device 602 has uplink data to transmit and again performs measurements on transmitted MRSs in the active mode, as shown in actions 6:8A-C. In the manner described above, the wireless device 602 will then access the RBS 600 in an action 6:9, by sending a PRACH preamble corresponding to the “best” received MRS out of the set of MRSs configured in action 6:1.

In this example, the serving RBS 600 configures the wireless device 602 with the set of serving MRSs in action 6:1, which MRSs are also used by wireless devices in the active mode, thus corresponding to actions 400 and 500. Further, the wireless device sends a PRACH preamble associated with one of the serving MRSs to the serving RBS 600, thus corresponding to actions 404 and 506.

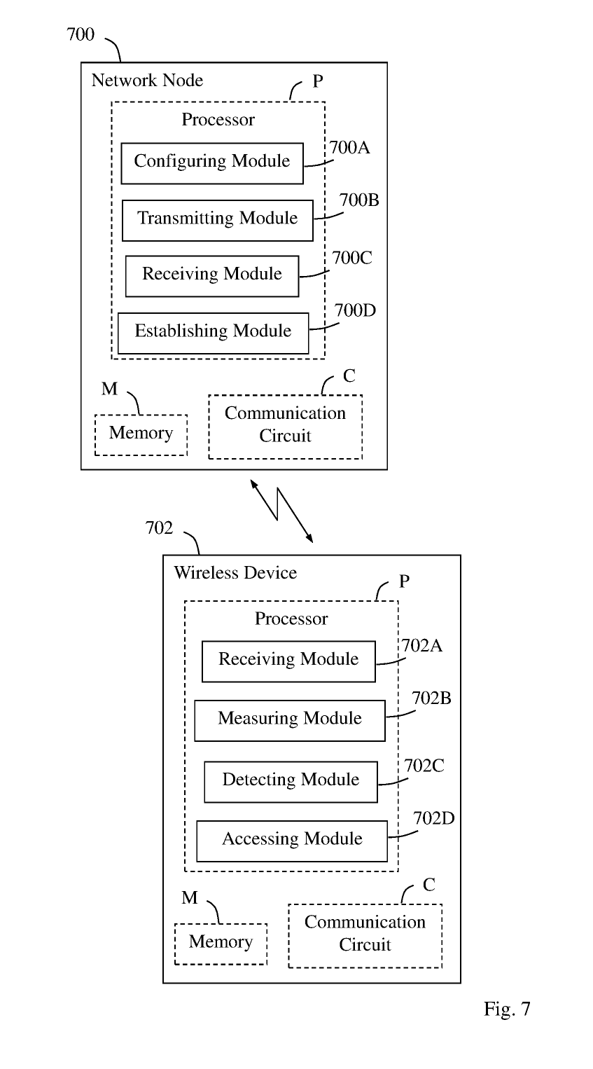

The block diagram in FIG. 7 illustrates a detailed but non-limiting example of how a network node 700 and a wireless device 702, respectively, may be structured to bring about the above-described solution and embodiments thereof. In this figure, the network node 700 and the wireless device 702 may be configured to operate according to any of the examples and embodiments of employing the solution as described herein, where appropriate. Each of the network node 700 and the wireless device 702 is shown to comprise a processor “P”, a memory “M” and a communication circuit “C” with suitable equipment for transmitting and receiving radio signals in the manner described herein.

The communication circuit C in each of the network node 700 and the wireless device 702 thus comprises equipment configured for communication with each other using a suitable protocol for the communication depending on the implementation. The solution is however not limited to any specific types of radio signals or protocols.

The network node 700 is, e.g. by means of units, modules or the like, configured or arranged to perform at least some of the actions of the flow chart in FIG. 4 as follows. Further, the wireless device 702 is, e.g. by means of units, modules or the like, configured or arranged to perform at least some of the actions of the flow chart in FIG. 5 as follows.

The network node 700 is arranged to enable a wireless device 702 to access a wireless network. The network node 700 is configured or operative to configure the wireless device 702 with a set of serving reference signals, such as a set of serving MRSs, to be measured by the wireless device 702 in inactive/idle mode, wherein the serving reference signals are also used by wireless devices in active mode. This configuring operation may be performed by a configuring module 700A in the network node 700, as illustrated in action 400. The network node 700 is further configured or operative to transmit the set of serving reference signals according to a predefined scheme. This operation may be performed by a transmitting module 700B in the network node 700, as illustrated in action 402.

The network node 700 is further configured or operative to receive from the wireless device 702 a Physical Random Access Channel, PRACH, preamble associated with one of the serving reference signals. This operation may be performed by a receiving module 700C in the network node 700 as illustrated in action 404. The network node 700 is further configured or operative to establish a connection with the wireless device 702 based on the received PRACH preamble. This operation may be performed by an establishing module 700D in the network node 700 as illustrated in action 406.

The wireless device 702 is arranged to access a wireless network. The wireless device 702 is configured or operative to receive from a serving network node 700 a configuration comprising a set of serving reference signals, such as a set of serving MRSs, wherein the serving reference signals are also used by wireless devices in active mode. This receiving operation may be performed by a receiving module 702A in the wireless device 702 as illustrated in action 500. The wireless device 702 is also configured or operative to perform measurements on the configured set of serving reference signals when the wireless device 702 is in inactive/idle mode. This operation may be performed by a measuring module 702B in the wireless device 702, as illustrated in action 502.

The wireless device 702 is further configured or operative to detect that a transition from inactive/idle mode to active mode is required or desirable. This operation may be performed by a detecting module 702C in the wireless device 702, as illustrated in action 504. The wireless device 702 is further configured or operative to access the wireless network by sending to the serving network node 700 a Physical Random Access Channel, PRACH, preamble associated with one of the measured serving reference signals that is the best, or at least acceptable, serving reference signal. This operation may be performed by an accessing module 702D in the wireless device 702, as illustrated in action 506.

It should be noted that FIG. 7 illustrates various functional modules in the network node 700 and the wireless device 702, respectively, and the skilled person is able to implement these functional modules in practice using suitable software and hardware equipment. Thus, the solution is generally not limited to the shown structures of the network node 700 and the wireless device 702, and the functional modules therein may be configured to operate according to any of the features, examples and embodiments described in this disclosure, where appropriate.

The functional modules 700A-D and 702A-D described above may be implemented in the network node 700 and the wireless device 702, respectively, by means of program modules of a respective computer program comprising code means which, when run by the processor P causes the network node 700 and the wireless device 702 to perform the above-described actions and procedures. Each processor P may comprise a single Central Processing Unit (CPU), or could comprise two or more processing units. For example, each processor P may include a general purpose microprocessor, an instruction set processor and/or related chips sets and/or a special purpose microprocessor such as an Application Specific Integrated Circuit (ASIC). Each processor P may also comprise a storage for caching purposes.

Each computer program may be carried by a computer program product in each of the network node 700 and the wireless device 702 in the form of a memory having a computer readable medium and being connected to the processor P. The computer program product or memory M in each of the network node 700 and the wireless device 702 thus comprises a computer readable medium on which the computer program is stored e.g. in the form of computer program modules or the like. For example, the memory M in each node may be a flash memory, a Random-Access Memory (RAM), a Read-Only Memory (ROM) or an Electrically Erasable Programmable ROM (EEPROM), and the program modules could in alternative embodiments be distributed on different computer program products in the form of memories within the respective network node 700 and wireless device 702.

The solution described herein may be implemented in each of the network node 700 and the wireless device 702 by a computer program comprising instructions which, when executed on at least one processor, cause the at least one processor to carry out the actions according to any of the above embodiments and examples, where appropriate. The solution may also be implemented at each of the network node 700 and the wireless device 702 in a carrier containing the above computer program, wherein the carrier is one of an electronic signal, optical signal, radio signal, or computer readable storage medium.

While the solution has been described with reference to specific exemplifying embodiments, the description is generally only intended to illustrate the inventive concept and should not be taken as limiting the scope of the solution. For example, the terms “network node”, “wireless device”, “serving reference signals”, “inactive/idle mode” and “PRACH preamble” have been used throughout this disclosure, although any other corresponding entities, functions, and/or parameters could also be used having the features and characteristics described here. The solution may be implemented according to the appended claims.

### Abbreviations

3GPP Third Generation Partnership Project
eNB Enhanced NodeB
ID Identity
LTE Long Term Evolution
MIB Master Information Block
MRS Mobility Reference Signal or Measurement Reference Signal
NR Next Radio
PBCH Physical Broadcast Channel
RBS Radio Base Station
SFN Single Frequency Network
SIB System Information Block
SS System Signature
TRP Transmission/Reception Point
UE User Equipment

1. A method performed by a network node of a wireless network, for enabling a wireless device to access the wireless network, the method comprising:
configuring the wireless device with a set of serving reference signals to be measured by the wireless device in inactive/idle mode, wherein the serving reference signals are also used by wireless devices in active mode,
transmitting the set of serving reference signals according to a predefined scheme,
receiving from the wireless device a Physical Random Access Channel, PRACH, preamble associated with one of the serving reference signals, and
establishing a connection with the wireless device based on the received PRACH preamble.

2. The method according to claim 1, wherein said set of serving reference signals is a set of serving Mobility Reference Signals MRSs which are transmitted as beamformed signals.

3. The method according to claim 2, wherein validity of the set of serving MRSs is per cell.

4. The method according to claim 2, wherein validity of the set of serving MRSs is for a set of multiple cells.

5. The method according to claim 2, wherein the wireless device is further configured with other non-serving MRS sets for comparison with the set of serving MRSs.

6. The method according to claim 5, wherein the wireless device is further configured with a timer which can be triggered by the wireless device upon entering the idle/inactive mode, and wherein duration of the timer is the validity period of the configuration related to the MRS sets and corresponding PRACH resources.

7. The method according to claim 2, wherein the wireless device is further configured with PRACH resources associated with the MRSs including said PRACH preamble, so that the wireless device can camp on the MRSs.

8. The method according to claim 1, wherein the method is applied on wireless devices that match a specific behaviour pattern of entering the inactive/idle mode and staying in an area covered by the set of serving reference signals.

9. A network node arranged to enable a wireless device to access a wireless network, wherein the network node is configured to:
configure the wireless device with a set of serving reference signals, to be measured by the wireless device in inactive/idle mode, wherein the serving reference signals are also used by wireless devices in active mode,
transmit the set of serving reference signals according to a predefined scheme,
receive from the wireless device a Physical Random Access Channel, PRACH, preamble associated with one of the serving reference signals, and
establish a connection with the wireless device based on the received PRACH preamble.

10. The network node according to claim 9, wherein said set of serving reference signals is a set of serving Mobility Reference Signals MRSs which are transmitted as beamformed signals.

11. The network node according to claim 10, wherein validity of the set of serving MRSs is per cell.

12. The network node according to claim 10, wherein validity of the set of serving MRSs is for a set of multiple cells.

13. The network node according to claim 10, wherein the wireless device is further configured with other non-serving MRS sets for comparison with the set of serving MRSs.

14. The network node according to claim 13, wherein the wireless device is further configured with a timer which can be triggered by the wireless device upon entering the idle/inactive mode, and wherein duration of the timer is the validity period of the configuration related to the MRS sets and corresponding PRACH resources.

15. The network node according to claim 10, wherein the wireless device is further configured with PRACH resources associated with the MRSs including said PRACH preamble, so that the wireless device can camp on the MRSs.

16. The network node according to claim 9, wherein the set of serving reference signals is applied on wireless devices that match a specific behaviour pattern of entering the inactive/idle mode and staying in an area covered by the set of serving reference signals.

17. A method performed by a wireless device for accessing a wireless network, the method comprising:
receiving from a serving network node a configuration comprising a set of serving reference signals, wherein the serving reference signals are also used by wireless devices in active mode,
performing measurements on the configured set of serving reference signals when the wireless device is in inactive/idle mode,
detecting that a transition from inactive/idle mode to active mode is required or desirable, and
accessing the wireless network by sending to the serving network node a Physical Random Access Channel, PRACH, preamble associated with one of the measured serving reference signals that is the best, or at least acceptable, serving reference signal.

18. The method according to claim 17, wherein said set of serving reference signals is a set of serving Mobility Reference Signals MRSs which are transmitted as beamformed signals.

19. The method according to claim 18, wherein validity of the set of serving MRSs is per cell.

20. The method according to claim 18, wherein validity of the set of serving MRSs is for a set of multiple cells.

21. The method according to claim 18, wherein the wireless device is further configured with other non-serving MRS sets for comparison with the set of serving MRSs.

22. The method according to claim 21, wherein the wireless device is further configured with a timer which can be triggered by the wireless device upon entering the idle/inactive mode, and wherein duration of the timer is the validity period of the configuration related to the MRS sets and corresponding PRACH resources.

23. The method according to claim 18, wherein the wireless device is further configured with PRACH resources associated with the MRSs including said PRACH preamble, so that the wireless device can camp on the MRSs.

24. The method according to claim 17, wherein the method is applied when the wireless device matches a specific behaviour pattern of entering the inactive/idle mode and staying in an area covered by the set of serving reference signals.

25. A wireless device arranged to access a wireless network, wherein the wireless device is configured to:
receive from a serving network node a configuration comprising a set of serving reference signals, wherein the serving reference signals are also used by wireless devices in active mode,
perform measurements on the configured set of serving reference signals when the wireless device is in inactive/idle mode,
detect that a transition from inactive/idle mode to active mode is required or desirable, and
access the wireless network by sending to the serving network node a Physical Random Access Channel, PRACH, preamble associated with one of the measured serving reference signals that is the best, or at least acceptable, serving reference signal.

26. The wireless device according to claim 25, wherein said set of serving reference signals is a set of serving Mobility Reference Signals MRSs which are transmitted as beamformed signals.

27. The wireless device according to claim 26, wherein validity of the set of serving MRSs is per cell.

28. The wireless device according to claim 26, wherein validity of the set of serving MRSs is for a set of multiple cells.

29. The wireless device according to claim 26, wherein the wireless device is further configured with other non-serving MRS sets for comparison with the set of serving MRSs.

30. The wireless device according to claim 29, wherein the wireless device is further configured with a timer which can be triggered by the wireless device upon entering the idle/inactive mode, and wherein duration of the timer is the validity period of the configuration related to the MRS sets and corresponding PRACH resources.

31. The wireless device according to claim 26, wherein the wireless device is further configured with PRACH resources associated with the MRSs including said PRACH preamble, so that the wireless device can camp on the MRSs.

32. The wireless device according to claim 25, wherein the wireless device matches a specific behaviour pattern of entering the inactive/idle mode and staying in an area covered by the set of serving reference signals.

33. (canceled)

34. (canceled)
